(19) United States
(12) Patent Application Publication
(10) Pub. No.: US 2013/0328876 A1
(43) Pub. Date: Dec. 12, 2013

(54) BUILDING KD-TREES IN A DEPTH FIRST MANNER ON HETEROGENEOUS COMPUTER SYSTEMS

(71) Applicant: Advanced Micro Devices, Inc., Sunnyvale, CA (US)

(72) Inventor: Sean Keely, Austin, TX (US)

(21) Appl. No.: 13/912,791

(22) Filed: Jun. 7, 2013

Related U.S. Application Data
(60) Provisional application No. 61/657,421, filed on Jun. 8, 2012.

(51) Int. Cl. G06T 15/06

(52) U.S. Cl. CPC G06T 15/06
USPC 345/426

(57) ABSTRACT

Apparatuses, computer readable mediums, and methods of building a k-dimensional tree (kd-tree) are disclosed. The method may include a first processor, for example a graphics processing unit (GPU), selecting a node to split in a depth first manner. The method may include the GPU splitting based on a split plane a node into a left node and a right node. The GPU may assign the left (right) node to the GPU when a number of polygons associated with the left (right) node is above a threshold and otherwise assign the left node to a second processor, for example a central processing unit (CPU). The CPU may build the kd-tree in a depth first manner. The GPU (CPU) may select a next node to split based on a last node assigned to the GPU (CPU) or by selecting a node that is currently in a local memory of the GPU (CPU).

### CROSS REFERENCE TO RELATED APPLICATIONS

This application claims the benefit of U.S. Pat. App. No. 61/657,421, filed on Jun. 8, 2012, the entire contents of which are hereby incorporated by reference herein.

### TECHNICAL FIELD

The disclosed embodiments are generally directed to constructing a k dimensional-tree (kd-tree), and in particular, to constructing a kd-tree using a heterogeneous computer system.

### BACKGROUND

A k-dimensional tree (kd-tree) is a structure for organizing elements such as triangles or polygons that are in a k-dimensional space. For example, kd-trees are used in computer graphics for ray tracing in many popular video games. Rays are traced through a space using a kd-tree to determine which polygons are in a region of the space near the ray. The ray can then be tested to see if it intersects with the polygons near the ray and not all the polygons. Kd-trees are used because they decrease the amount of time it takes to run many applications. However, it can be time consuming to construct the kd-tree. Additionally, computer systems that include two or more different types of processors may be called heterogeneous processor systems. Often, the different types of processors are not well utilized.

Therefore, there is a need in the art for an apparatus, computer readable medium, and method of constructing a kd-tree in a heterogeneous processor system.

### SUMMARY OF EMBODIMENTS

Some disclosed embodiments provide a method of building a k-dimensional tree (kd-tree). The method may include a first processor of a first type—e.g., a graphics processing unit (GPU)—splitting a node associated with a plurality of polygons into a left node associated with a left portion of the plurality of polygons and a right node associated with the a right portion of the plurality of polygons. The splitting may be based on a split plane. The method may further include the GPU assigning the left node associated with the left portion of the plurality of polygons to the GPU when a number of the left portion of the plurality of polygons is above a threshold and otherwise assigning the left node associated with the left portion of the plurality of polygons to a second processor of a second type—e.g., central processing unit (CPU). The method may further include the GPU assigning the right node associated with the right portion of the plurality of polygons to the GPU when a number of the right portion of the plurality of polygons is above a threshold and otherwise assigning the right node associated with the right portion of the plurality of polygons to the CPU. The threshold may be based on a size of a CPU cache or a number of threads running on the GPU.

The GPU (or CPU) may select the node to split based on a depth first manner of building the kd-tree. In some disclosed embodiments, the GPU (or CPU) may select the node to split based on a depth first manner of building the kd-tree by selecting a last node assigned to the GPU (or CPU) or by selecting a node that is currently in a local memory of the GPU (or CPU.)

Some embodiments provide a computer readable non-transitory medium including instructions which when executed in a processing system cause the processing system to execute a method for building a kd-tree.

### BRIEF DESCRIPTION OF THE DRAWINGS

A more detailed understanding may be had from the following description, given by way of example in conjunction with the accompanying drawings wherein:

FIG. 1 is a block diagram of an example device in which one or more disclosed embodiments may be implemented;

FIG. 2A schematically illustrates a kd-tree according to some disclosed embodiments;

FIG. 2B schematically illustrates a geometric interpretation of the kd-tree of FIG. 2A;

FIG. 3 schematically illustrates a system for building a kd-tree according to some disclosed embodiments;

FIG. 4 schematically illustrates a method for determining where to split a node of a kd-tree according to some disclosed embodiments;

FIGS. 5A, 5B, and 5C schematically illustrate the operation of the method of FIG. 4 according to some disclosed embodiments;

FIGS. 6A and 6B illustrate a method of building a kd-tree according to some disclosed embodiments for a GPU;

FIG. 7 illustrates a method of building a kd-tree according to some disclosed embodiments for a CPU;

FIGS. 8A, 8B, 8C, 8D, and 8E illustrates the operation of the method 600 of FIGS. 6A and 6B and the method 700 of FIG. 7; and

FIG. 9 illustrates estimated speedup times for constructing a kd-tree using a heterogeneous computer system compared with a CPU building a kd-tree, according to some disclosed embodiments.

### DETAILED DESCRIPTION OF EMBODIMENT(S)

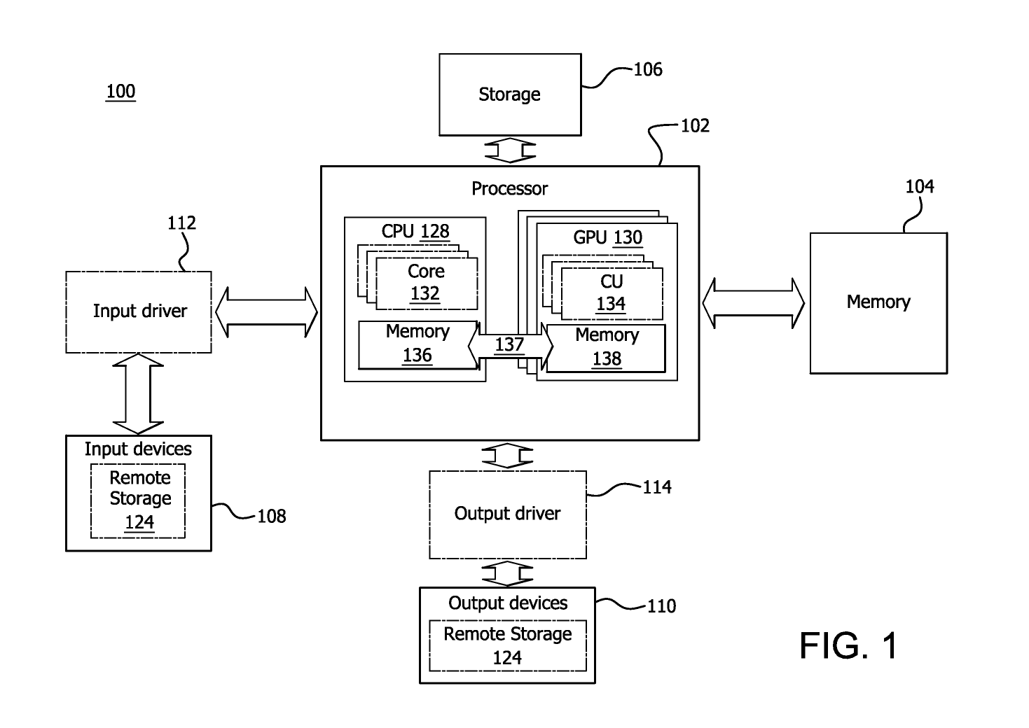

FIG. 1 is a block diagram of an example device 100 in which one or more disclosed embodiments may be implemented. The device 100 may include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 may also optionally include an input driver 112 and an output driver 114. It is understood that the device 100 may include additional components not shown in FIG. 1.

The processor 102 may include processing units of different types—e.g., one or more central processing units (CPU) 128, which may include one or more cores 132 (i.e., a first processor type), and one or more graphics processing unit (GPU) 130, which may include one or more compute units (CU) 134 or GPU cores (i.e., a second processor type). As known to those of ordinary skill in the art, processors of types different to the CPU and GPU are known. These other processors include, for example, digital signal processors, application processors and the like. The CPU 128 and GPU 130 may be located on the same die, or multiple dies. The CUs 134 may be organized into groups with a processing control (not illustrated) controlling a group of CUs 134. A processing control may control a group of CUs 134 such that the group of CUs 134 perform as a single instruction multiple data (SIMD) processing units (not illustrated). The CU 134 may include a memory 139 that may be shared with one or more other CUs 134. For example, a processing control may control 32 CUs 134, and the 32 CUs 134 may all share the same memory 139 with the processing control.

The GPU 130 and the CPU 128 may be other types of computational elements. The CPU 128 may include memory 136 that is shared among cores of the CPU 128. In some disclosed embodiments, the memory 136 is an L2 cache. The GPU 130 may include memory 138 that is shared among the CUs 134 of one or more GPUs 130. Data may be transferred via 137 between the memory 136 and memory 138 and memory 139. The GPU 130 and CPU 128 may include other memories such as memory for each core 132 and memory for each of the processing units of the CU 134 that is not illustrated. The memories 136, 138, and 138 may be part of a cache system (not illustrated), or may not be coherent memory. The memory 104 may be located on the same die as the processor 102, or may be located separately from the processor 102. The memory 104 may include a volatile or non-volatile memory, for example, random access memory (RAM), dynamic RAM (DRAM), or a cache.

The storage 106 may include a fixed or removable storage, for example, a hard disk drive, a solid state drive, an optical disk, or a flash drive. The input devices 108 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 may include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present.

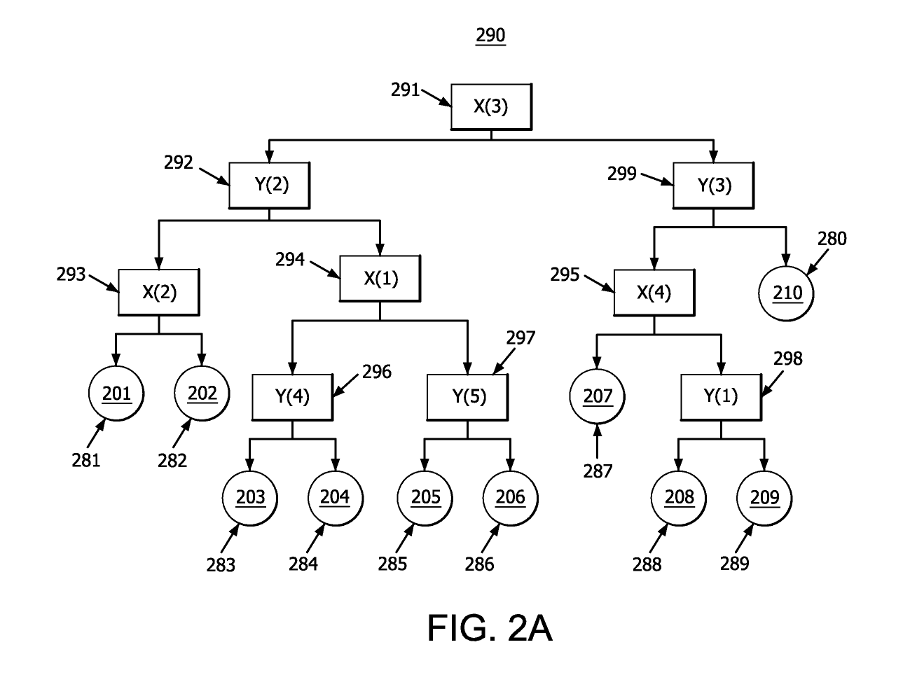

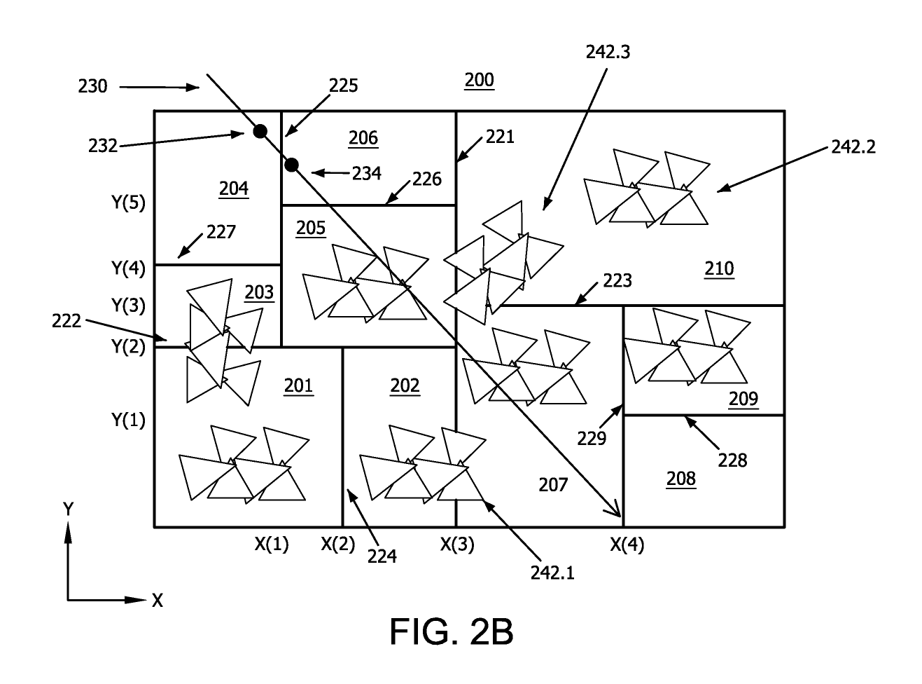

FIG. 2A schematically illustrates a kd-tree according to some disclosed embodiments. FIG. 2B schematically illustrates a geometric interpretation of the kd-tree of FIG. 2A. Illustrated in FIG. 2A is a kd-tree 290 with nodes 291, 292, 293, 294, 295, 296, 297, and 298, with the corresponding dimension values X(3), Y(2), Y(3), X(2), X(1), Y(4), Y(5), X(4), and Y(1), indicated in the node; and, node primitives 280, 281, 282, 283, 284, 285, 286, 287, 288, 289, with the corresponding region 201, 202, 203, 204, 205, 206, 207, 208, 209, and 210, indicated in the node primitives. Each node 291, . . . , 298 represents a dimension and split plane 221, . . . , 229, for the geometric space 200 and the node primitives 280, . . . , 289, represent a region 201, . . . , 210, and the primitives 242 associated with the region 201, . . . , 210.

Illustrated in FIG. 2B is a k-dimensional geometric space 200; regions 201, 201, 202, 203, 204, 205, 206, 207, 208, 209, and 210; split planes 221, 222, 223, 224, 225, 226, 227, 228, and 229; primitives 242 that are polygons or triangles; and, a ray 230.

The k-dimensional geometric space 200 is a 2 dimensional x, y space. The k-dimensional geometric space 200 may have more than 2 dimensions. For example, in 3D graphics there are 3 dimensions x, y, and z space. The kd-tree 290 splits the k-dimensional geometric space at each node. For example, node 291 splits the geometric space 200 at x value X(3). The split plane 221 illustrates where the geometric space is split by X(3). All of the triangles 242 that are less than X(3) are to the left of node 291 on the kd-tree 290 and all the triangles that are greater than X(3) are to the right of the node 291 on the kd-tree 290. The triangles 242 that are intersected by the split plane 221 may in some embodiments be duplicated on both sides of node X(3). For example, triangle 242.1 may be both on the right side of node X(3) and on the left side of node X(3). In some embodiments, the triangle 242.1 may be split so that only the right portion of the triangle 242.1 is on the right side of node 291 and only the left portion of triangle 242.1 is on the left side of node 291.

Continuing with the example, node 291 splits the geometric space 200 at X(3) and then nodes 292 and 299 split the geometric space 200 at split planes 222, and 223 respectively. Split plane 222 is at dimension value or y value Y(2). Split plane 223 is at y value Y(3). So, the dimension is shifted from X to Y for splitting the geometric space 200 in going from node 291 to nodes 292 and 299. In some disclosed embodiments, the dimension may not shift to a different dimension, or may shift to a different dimension based on determining a cost of traversing the kd-tree 290. The kd-tree 290 then splits the geometric space 200 with nodes 293, 294, and 295 at split planes 224, 225, and 229, respectively. The split planes 224, 225, and 229, occur at x values X(2), X(1), and X(4) respectively. On the right side of node 291 of the kd-tree 290, there is not another node, but node primitives 280 which represents that the geometric space 200 is not split anymore and that node primitives 280 includes the triangles 242.2 in region 210, which is bounded by split plane 221 and split plane 223. For example, the node primitives 210 may have a pointer to an array of the triangles 242.2, 242.3, in region 210.

The example continues with nodes 296, 297, and 298, splitting the geometric space 200 with split planes 227, 226, and 228, respectively. Nodes 296, 297, and 298, split the space 200 at y values Y(4), Y(5), and Y(1), respectively. At this point, the geometric space is split into a number of regions 201, 202, 203, 204, 205, 206, 207, 208, 209, and 210, with the triangles 242 all being in one or more of the regions 201, 202, 203, 204, 205, 206, 207, 208, 209, and 210 based on the geometric location of the triangles 242.

The following illustrates how a kd-tree 290 is used. In computer graphics, one method of rendering a scene is ray tracing. In ray tracing, rays 230 are traced back from the eye of the observer of the scene to determine what a light ray 230 would have intersected in the geometric space 200. Values for the light ray 230 can then be determined for the observer of the scene. For example, to trace ray 230 through geometric space 200 we start with a point 232 where the ray 230 comes into the geometric space 200. The question to determine for ray tracing is which, if any, triangles 242 does the ray 230 intersect. A simple approach would determine whether or not the ray 230 intersects any of the triangles 242 for the entire geometric space 200. However, this may be cost prohibitive as there may be many millions of triangles 242 in a geometric space 200. An object such as a teapot is often represented with polygons or triangles.

Which region 201, 202, 203, 204, 205, 206, 207, 208, 209, 210 the point 232 lays in may be determined as follows. The method starts at the top of the kd-tree 290. Point 232 is to the left of node 291 for the x dimension, since by inspection of geometric space 200 point 232 is to the left of X(3) and split plane 221. The method of finding the region is explained with inspection of the geometric space 200 and points 232, 234 rather than actual x and y values for ease of explanation. In the example, the x and y coordinates of geometric space 200 may vary from 0 to 1000. X(3) may be 500 and point 232 may be at x=200, y=900. The system 100 would then be comparing the x and y coordinates of the point 232 with the split plane X(3) value. The first test would be x=200 (x value of point 232) is less than x=500, X(3) value.

So, the point 232 is then to the left of node X(3). So, node 292 of kd-tree 290 is then examined. Node 292 is based on a split plane 222 of the y coordinate at value Y(2). Point 232 is clearly greater than Y(2) or split plane 222. So, node 294 is next examined which is based on split plane 225, which is an x-coordinate split of the geometric space 200 at X(1). Point 232 is clearly less than split plane 225, so node 296 is examined. Point 232 is clearly greater than Y(4) or split plane 227, so that leads to node primitives 284, which corresponds to region 204 (FIG. 2B). Reaching node primitives 284 indicates that there are no more divisions of the geometric space 200. The point 232 is then is in region 204. Node primitives 284 indicates there are no triangles in region 204. The ray 230 is then intersected with region 204 to determine the next point 234. The kd-tree 290 may then be used to determine that point 234 is in region 206. The method may continue to trace the ray 230 through each of the regions 204, 206, 205, and 207 that the ray 230 would pass through. The ray 230 will be determined to intersect with triangles in region 205 and 207. The method will then determine what the intensity and color of the ray 230 should be based on the intersection with the triangles in region 205 and 207. The method may determine the affect of light sources on the intersected triangles 242. By tracing many rays 230 back from the observer, a graphics scene may be rendered.

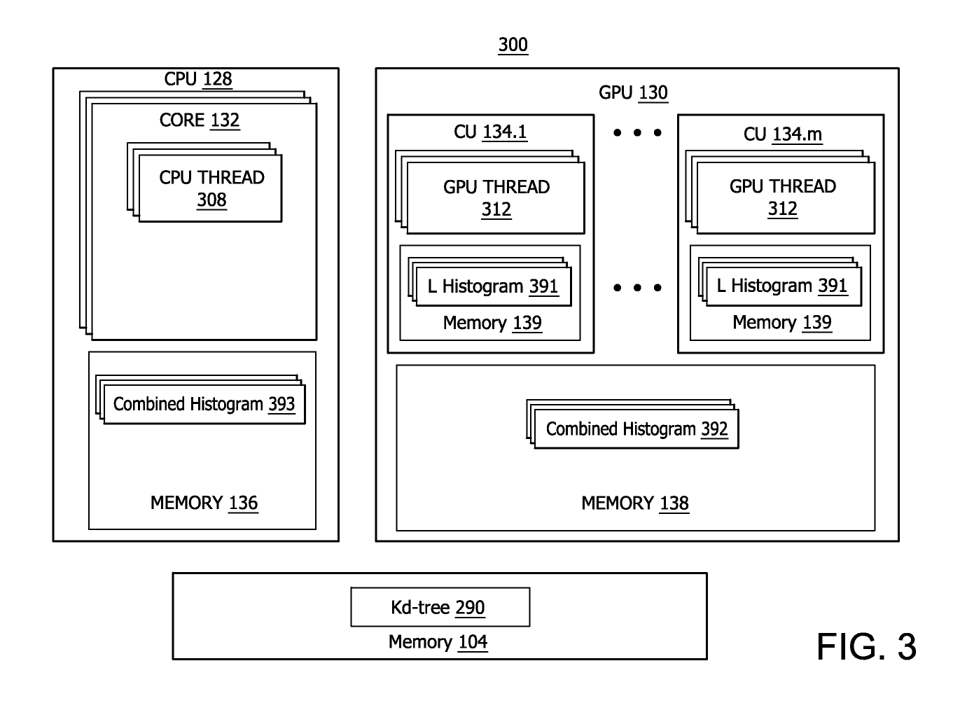

FIG. 3 schematically illustrates a system 300 for building a kd-tree according to some disclosed embodiments. The system 300 includes a CPU 128, GPU 130, and memory 104. The CPU 128 may include CPU threads 308, and memory 136, which may include combined histogram 393. The CPU threads 308 may be configured to build a kd-tree 290. The GPU 130 may include GPU thread 312, L Histogram 391, and combinedHistogram 392. The GPU thread 312 may be configured to build a kd-tree 290. The L Histogram 391 may be a data structure that is local to one or more GPU threads 312 that is used to build the kd-tree 290. The combined Histogram 392 may be a data structure that is used by one or more of the GPU threads 312 to build a kd-tree 290. The kd-tree 290 may reside wholly in the memory 104 or may reside partially in other memories in system 300. In some disclosed embodiments, the kd-tree 290 may be represented by indexes in memory 136, 139, or 138 that index to the actual values in memory 104.

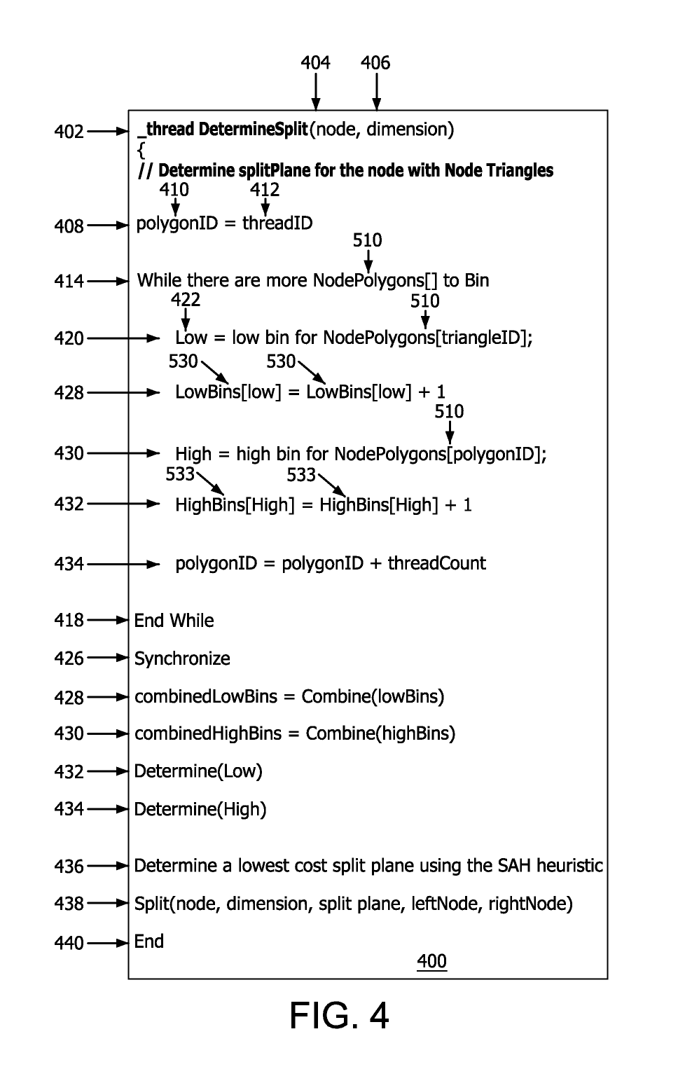

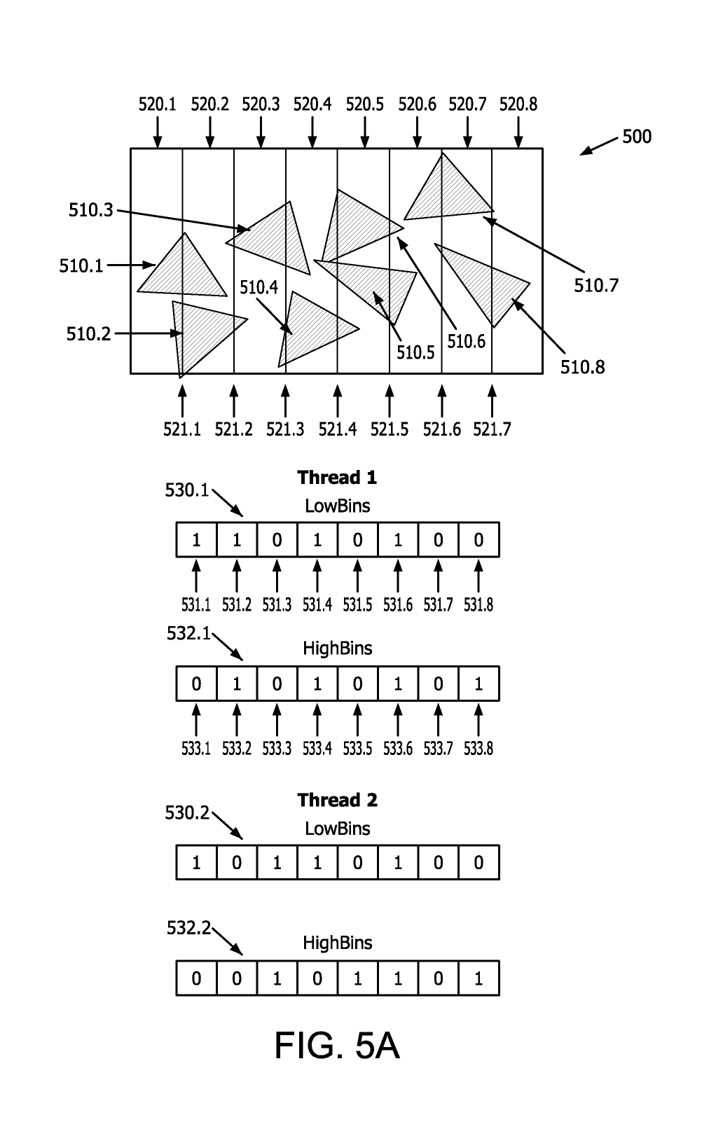

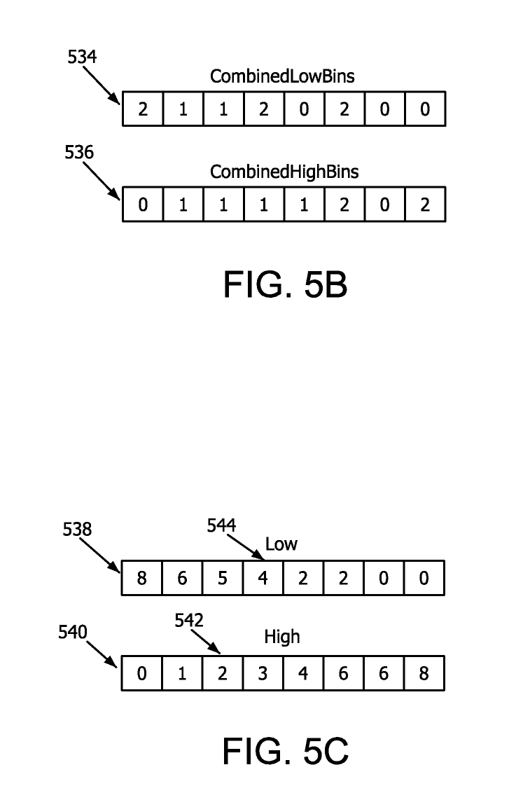

FIG. 4 schematically illustrates a method for determining where to split a node of a kd-tree according to some disclosed embodiments. The method 400 may be a thread that may be a CPU thread 308 or a GPU thread 312. The method 400 is called determineSplit 402 and is called with a node 404 and dimension 406 to split the node 404 with. Method 400 is described in conjunction with FIGS. 5A, 5B, and 5C.

FIGS. 5A, 5B, and 5C schematically illustrate the operation of the method of FIG. 4 according to some disclosed embodiments. Illustrated in FIG. 5A are a geometric space 500, bins 520, polygons 510, split planes 521, lowbins 530, and highbins 532. Illustrated in FIG. 5B are combinedLowbins 534, and combinedHighbins 536. Illustrated in FIG. 5C are Low 538, and High 540.

Returning back to determineSplit 402, the method is called with a top level node 404 that indicates all the polygons 510 in the geometric space 500. The method 400 will determine which split plane 521 will provide a low cost for searching the kd-tree 290 that is being built. For example, referring to FIG. 5A, if splitplane 521.4 is selected, then polygons 510.1, 510.2, 510.3, and 510.4 would be on a left node and polygons 510.5, 510.6, 510.7, and 510.8 would be on a right node. The method 400 uses a method called the surface area heuristic to estimate the cost of searching the kd-tree 290 that is built. In some disclosed embodiments, a different method may be used to determine the cost of searching the kd-tree 290 that is built.

The method 400 continues with polygoneID=threadID 408. The polygonID 410 will be used to access polygons that are associated with the node 404. The threadID 412 is an identification of a GPU thread 312 (see FIG. 3) or CPU thread 308. For example, 1024 GPU threads 312 may be used to split the node 404. Each of the GPU threads 312 will be given a unique identification such as 1 or 734. In the example of FIG. 5, there are two GPU threads 312, thread 1 and thread 2 (see FIG. 5A) that have threadIDs 412 of 1 and 2. Each of the GPU threads 312 runs separately and then waits for each other at synchronize 426. The method 400 is explained in the context of thread 1 and thread 2 (see FIG. 5A); however, often thousands of threads will be active.

The method 400 continues with “while there are more nodepolygons[ ] 510 to Bin” 414. The while 414 will loop from 414 to 418 while there are more nodepolygons[ ] 510 to bin. There are 8 polygons 510 in nodepolygons[ ] in the example of FIG. 5, but thread 1 will only do every other polygon 510 since there are two threads.

The method 400 continues with “low=low bin for nodepolygons[polygonID]” 420. A low bin is determined by thread 1 for the nodepolygons[polygonID] 510. For example, in FIG. 5A, nodepolygon[polygonID=1] 510, which will be the first polygon or 510.1. The first polygon 510.1 will have a low of bin 520.1 so low=1. The method 400 continues with “LowBins[low]=LowBins[low]+1” 428. The value of bin 531.1 of lowBins 530.1 (FIG. 5A) will be increased from 0 to 1.

The method 400 continues with “high=high bin for NodePolygons[polygonID]” 430. PolygonID is still 1, so the high for nodepolygon[1], which is polygon 510.1 (FIG. 5A) is bin 520.2, so high=2.

The method 400 continues with “Highbins [High]=HighBins[High]+1,” 432, which will be HighBins[2]=HighBins[2]+1, so that 1 is added to 533.2 (FIG. 5A). Thread 1 has now processed its first NodePolygon[ ] 510.

The method 400 continues with “polygonID=polygonID+threadCount” 434. PolygonID is currently 1 and threadCount is 2, so polygonID is set to 3. So, thread 1 will do the odd number polygons of FIG. 5 and thread 2 will do the even number polygons in FIG. 5. If there were 1,000 threads and 2,000,000 polygons, then each thread would do 2,000 polygons.

The method 400 continues with thread 1 counting all the high and low positions of the polygons 510 so that lowBins 530.1 and highBins 530.1 are determined as illustrated in FIG. 5A. Note that the sum of each of lowBins 530.1 and highBins 530.1 is 4 as thread 1 does half of the polygons 510. Thread 2 does the other half of the polygons 510 so that lowBins 530.2 and highBins 532.2 are determined as illustrated in FIG. 5. Thread 1 and thread 2 then wait for each other to finish at synchronize 426. In this way 1000's of threads can cooperate to bin the polygons 510 into lowBins 530 and HighBins 532.

The method 400 may continue with “combinedLowBins=Combine(lowBins)” 428. The lowBins 530.1 and lowBins 530.2 may be combined into combinedLowBins 534 (FIG. 5B). The method 400 may continue with “combinedHighBins=Combine(highBins)” 430. The highBins 532.1 and highBins 532.2 may be combined into combinedHighBins 536 (FIG. 5B). In some disclosed embodiments, the CPU may perform method 400 and store the lowBins 530, the highBins 532, combinedLowBins 534, and combinedHighBins 534, in memory 136, which may be a cache memory. In some disclosed embodiments, the NodePolygons 510 is an array of indexes to an array of polygons. The NodePolygons 510 may be stored in a memory 138 of the GPU 130. In some disclosed embodiments, the NodePolygons 510 may be stored in memory 139 of the GPU 130. In some disclosed embodiments, the lowBins 530, highBins 532, and combinedHighBins 534 may be stored in memory 139 of the GPU 130.

The method 400 may continue with “Determine(Low)” 432. The method 400 may determine the Low 538 (FIG. 5C) as a prefix sum of combinedLowBins 534. The method 400 may continue with “Determine(High)” 434. The method 400 may determine High 540 (FIG. 5C) as a suffix sum of combinedHighBins 536. Low 538 and High 540 may be used to split the node 404 and for estimating the cost of the kd-tree 290 being built to be traversed. For example, if split plane 521.3 were selected to split the node 404, then the left node would have 2 full polygons 510.1 and 510.2, which is High [3] 542. The right node would have 4 full polygons 510.5, 501.6, 510.7, and 510.8, which is low [3+1]=4. And, the number of polygons that are intersected by split plane 521.3 is two 510.3 and 510.4, which is 8 (total number of polygons)−Low [3+1]−High[3], or 8−4−2, or 2. So, Low 538 and High 540 can be used to determine the number of polygons to the left of a split plane 521, to the right of the split plane 521, and that intersect a split plane 521.

The method 400 may continue with “determine a lowest cost splitPlane using the SAH heuristic” 436. For example, the following heuristic may be used.

C_{SAM}=(S_{L}/S_{P})C_{L}+(S_{R}/S_{P})C_{R}, where C_{SAM} is the estimated cost to search the split kd-tree; S_{P} is the surface area of the node being split; S_{L} is the surface area of the left node; S_{R} is the surface area of the right node; C_{L} is the estimated cost of intersecting the left node; and, C_{L} estimated cost of intersecting the left node. The heuristic works by estimating the cost based on surface area of a node times the number of polygons in the node. For example, to test splitPlane 321.3 the C_{SAM} would be S_{L}=3 (3 bins), S_{P}=8 (8 bins), C_{L} (2 polygons+2 intersected polygons), S_{R}=5 (5 bins), and C_{R}=(4 polygons+2 intersected polygons.) The C_{SAM} for splitPlane 321.3 is then =(⅜)*4+(⅝)*6=42/8, or 5¼. This is an estimate of the expected cost of using or searching the kd-tree if it is split at 321.3 for an application such as ray tracing. The costs for each of the split planes 521 are determined and the lowest cost split plane 521 is selected. In some embodiments, another method may be used to determine the costs of searching the kd-tree for different splitPlanes 321. In some embodiments, the determineSplit 402 may determine not to split the node based on a minimum number of polygons associated with node.

The method 400 may continue with “split(node, dimension, splitPlane, leftNode, rightNode)” 438. Split splits the node into a leftNode and rightNode based on the splitPlane 321. The polygons 510 may be split using the lowBins 530 and highBins 532. In some embodiments, split 438 may be performed in parallel with many threads. In some embodiments, method 400 may not split the node. In some disclosed embodiments split 438 may be one or more GPU threads 312. In some disclosed embodiments, split 438 may be one or more CPU threads 308. In some disclosed embodiments, split 438 and determinesplit 402 may be persistent GPU threads 312. The method 400 may then end 440.

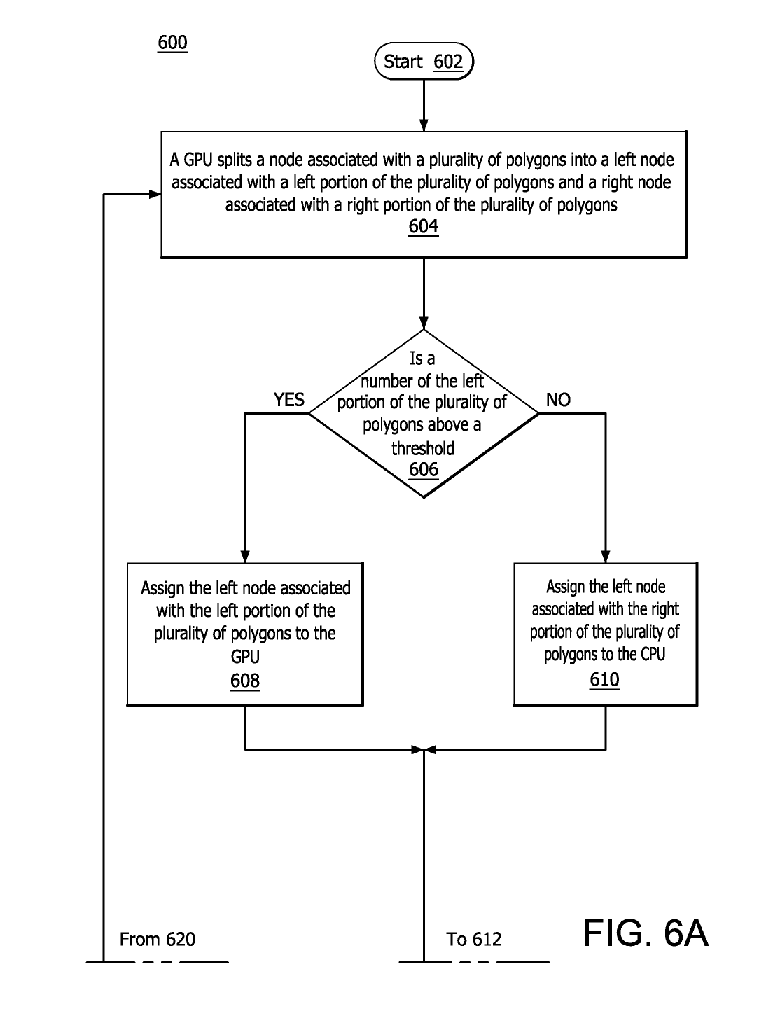

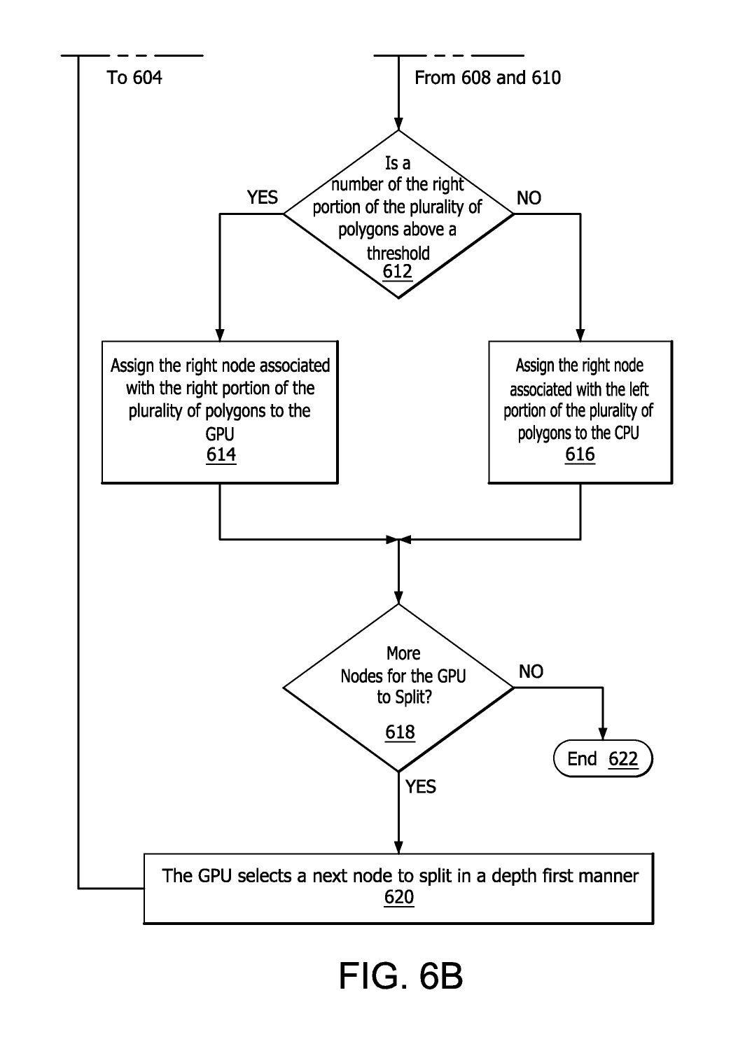

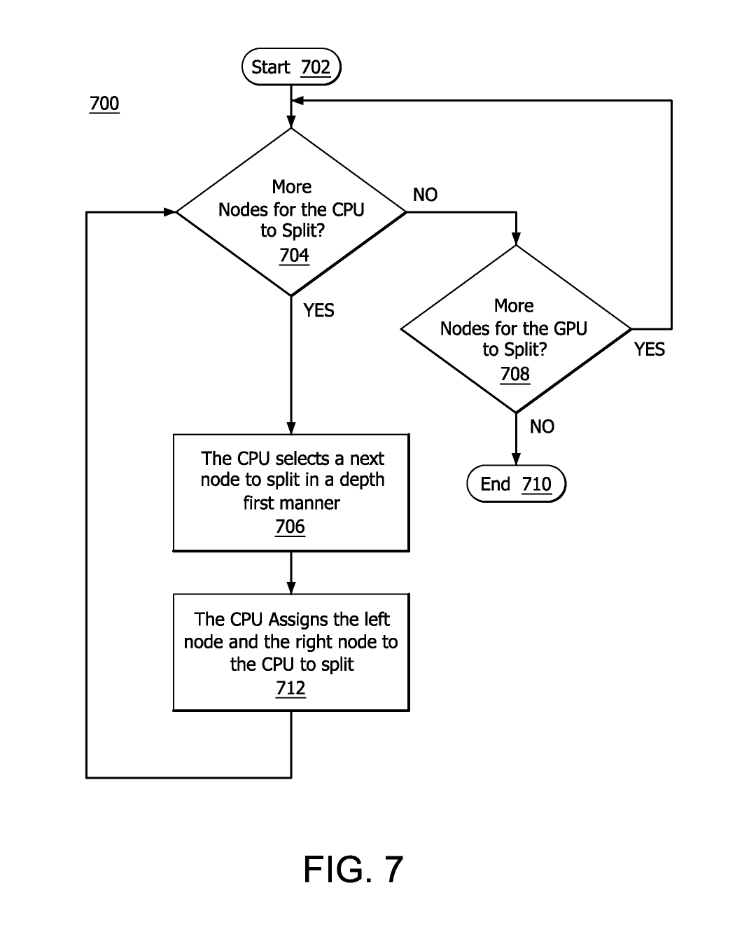

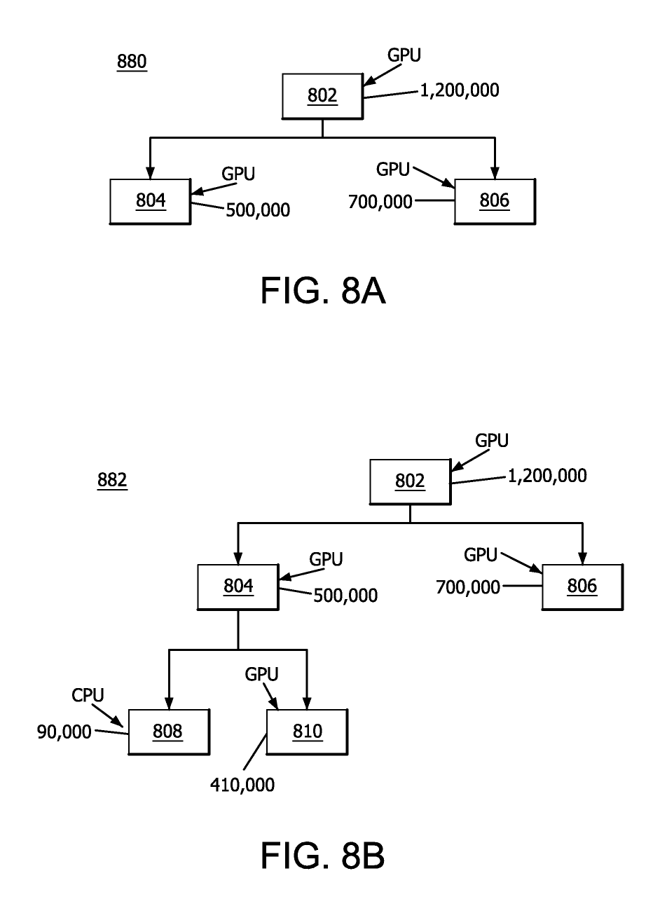

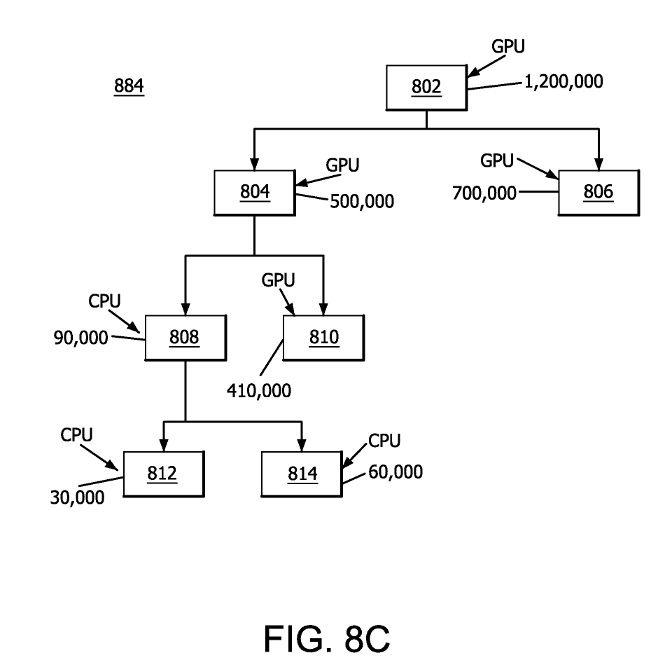

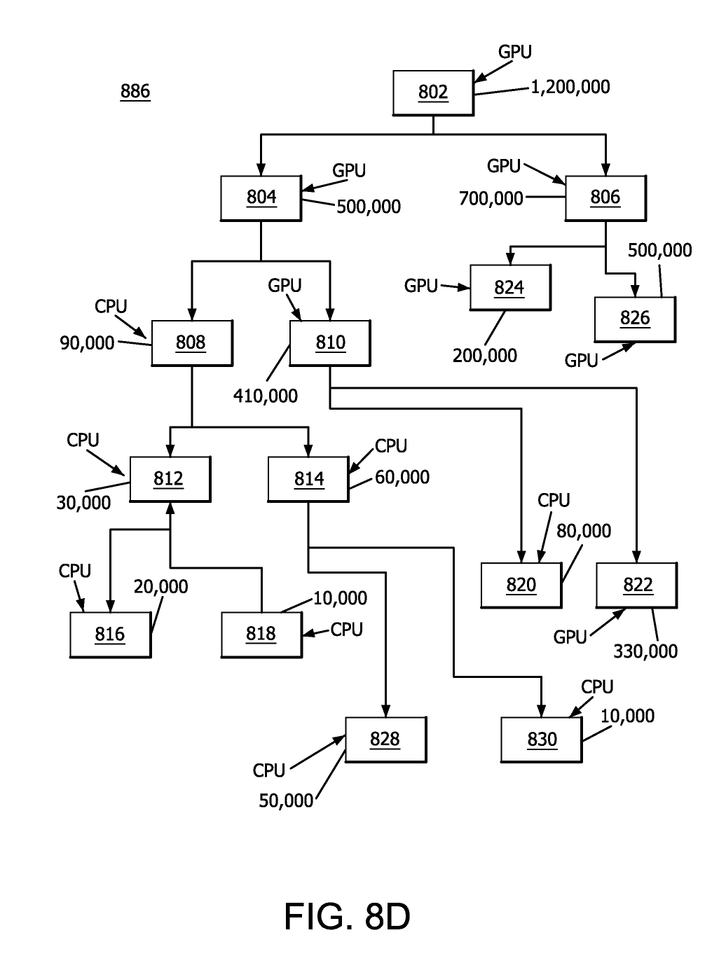

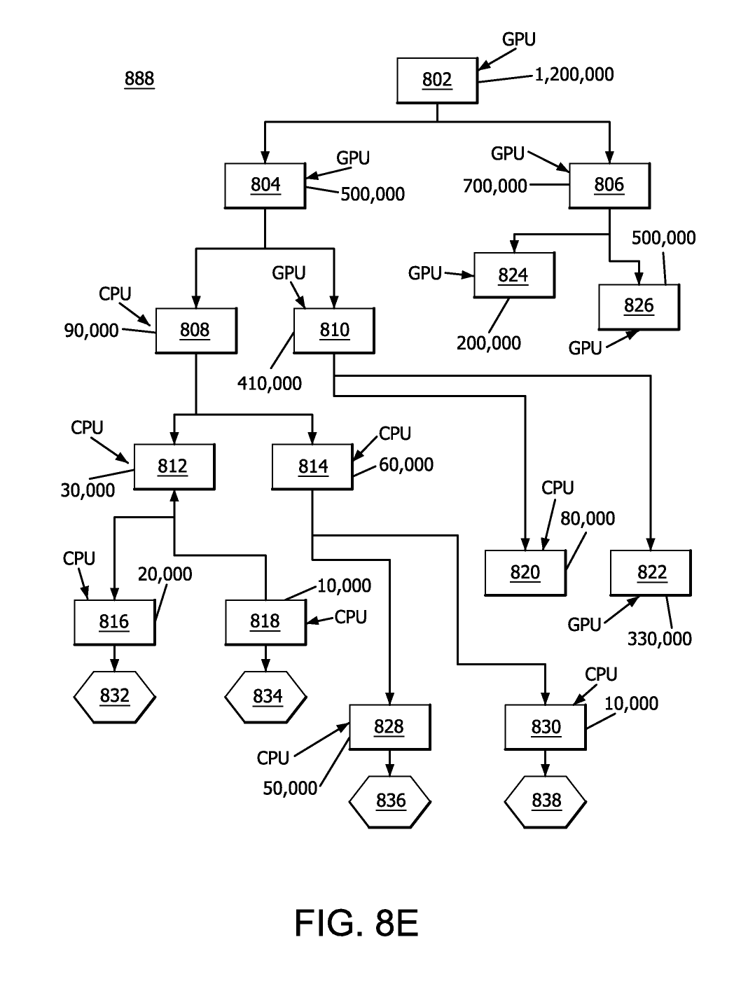

FIGS. 6A and 6B illustrate a method of building a kd-tree according to some disclosed embodiments for a GPU. FIG. 7 illustrates a method of building a kd-tree according to some disclosed embodiments for a CPU. The method 600 may be performed at the same time as the method 700. The methods 600 and 700 will be described together with an example illustrated in FIGS. 8A, 8B, 8C, 8D, and 8E.

The method 600 may begin with start 602. The method 600 may continue with a GPU splits a node associated with a plurality of polygons into a left node associated with a left portion of the plurality of polygons and right node associated with a right portion of the plurality of polygons 604. For example, the GPU may be running GPU threads 312 (FIG. 3), which may perform the method 400 (FIG. 4).

FIGS. 8A, 8B, 8C, 8D, and 8E illustrate the operation of the method 600 of FIGS. 6A and 6B and the method 700 of FIG. 7. Illustrated in FIG. 8A is a kd-tree 880 with node 802 split into a left node 804 and a right node 806. The left node 802 has 500,000 polygons associated with it and the right node 806 has 700,000 associated with it. The node 802 has 1,200,000 which is the sum of the polygons 500,000 associated with the left node 804 and the polygons 700,000 associated with the right node 806. This example ignores the polygons that are intersected by the split plane 521 and may be duplicated on both the left node 804 and the right node 806.

The method 600 may continue with is a number of the left portion of the plurality of polygons above a threshold 606. For example, the threshold may be 100,000 polygons, and the number of polygons associated with the left node 804 is 500,000, which is above the threshold of 100,000. The threshold may be statically or dynamically determined. The threshold may be determined based on a size of the memory 136 or the respective processing performance of the processors available to generate or process the kd-tree. For example, the threshold may be set so that the number of polygons can all fit in memory 136 or, alternatively or additionally, be processed with the best performance (with performance covering one or more metrics typically associated with performance—e.g., time to completion, power consumed, processing capacity of the respective processors available for processing or generating a kd-tree while other processes/applications are also being processed on the system, etc.).

The method 600 continues with assign the left node associated with the left portion of the plurality of polygons to the GPU 608. For example, the left node 804 may be assigned to the GPU in a queue or ring buffer.

The method 600 continues with is a number of the right portion of the plurality of polygons above a threshold 612. For example, the threshold may be 100,000 polygons, and the number of polygons associated with the right node 806 is 700,000, which is above the threshold of 100,000. The method 600 continues with assign the right node associated with the left portion of the plurality of polygons to the GPU 612. For example, the right node 804 may be assigned to the GPU in a queue or ring buffer.

The method 600 may continue with more nodes for the GPU to split 618. Continuing with the example, there are two nodes for the GPU to split, the left node 804 and the right node 806. The method 600 continues with the GPU selects a next node to split in a depth first manner 620. Continuing with the example, the GPU could select either the left node 804 or the right node 806 for the splitting to be performed in a depth first manner. In some disclosed embodiments, the GPU selects the left node 804 to split. By selecting nodes in a depth first manner, the GPU may select nodes that are already in the memory 138 and memory 139 of the GPU 130.

The method 600 returns to 604 where the GPU splits node 804, into left node 808 with 90,000 polygons associated with it and right node 810 with 410,000 polygons associated with it.

The method 600 continues with is a number of the left portion of the plurality of polygons above a threshold 606. For example, the number of polygons 90,000 associated with the left node 808 is not above the threshold of 100,000. The method 600 proceeds to assign the left node 808 associated with the right portion of the plurality of polygons to the CPU. For example, the left node 808 may be assigned to a ring buffer or queue for the CPU to process.

Since left node 808 has been assigned to the CPU to process, the method 700 will be described. Method 700 may begin with start 702. Method 700 may continue with more nodes for the CPU to split 704. Continuing with the example, the CPU would have left node 808 to split. The method may continue with the CPU selects a next node to split in a depth first manner 706.

For example, referring to FIG. 3, the CPU 128 may be running CPU threads 308 on one or more cores 132. The CPU threads 308 may be methods such as method 400 of FIG. 4 for building a kd-tree. The CPU threads 308 may keep references to the polygons in the memory 136 when the threshold is small enough so that all the references to the polygons can be kept in memory 136.

As illustrated in FIG. 8C, the CPU may then split the node 808 into left node 812 with 30,000 polygons associated with it and a right node 814 with 60,000 polygons associated with it. The method 700 may continue with the CPU assign the left node and the right node to the CPU to split 712. For example, the CPU assigns left node 812 and right node 814 to the CPU to split.

Switching back to method 600 which is performed at the same time as method 700, the method 600 continues with is a number of the right portion of the plurality of polygons above a threshold 612. Continuing with the example, 410,000 polygons associated with the right node 810 is above the threshold. The method 600 continues with assign the right node associated with the right portion of the plurality of polygons to the GPU 614, which is illustrated in FIG. 8D. Continuing with the example, right node 810 is assigned to the GPU.

The method 600 continues with more nodes for the GPU to split 618. Continuing with the example, nodes 810 and 806 are assigned to the GPU, so there are more nodes for the GPU to split. FIG. 8D illustrates whether the GPU or the CPU was assigned to a node. For example, node 824 was assigned to the GPU and node 808 was assigned to the CPU.

The method 600 continues with the GPU selects a next node to split in a depth first manner 620. Continuing with the example, the GPU has node 810 and node 806 assigned to it. The GPU may split node 810 next. In some embodiments, the GPU may split nodes 810 and 806 at the same time. Referring to FIG. 8D, additionally, as the GPU splits node 810 into left node 820 and right node 822, and node 806 into left node 824 and right node 826, the CPU may continue to perform method 700 by splitting node 812 into left node 816 and right node 818, and node 814 into left node 828 and right node 830.

Continuing with the CPU and method 700, method 700 may continue with more nodes for the CPU to Split 704. There are currently 5 nodes for the CPU to split: node 816, node 818, node 828, node 830, and node 820. The method 700 may continue with the CPU selects a next node to split in a depth first manner 706. The CPU may select node 816, node 818, node 828, and node 830, which may all be split by CPU threads 308 at the same time. The CPU may not select node 820 as this is a new node and the CPU may not have enough memory 136 to store the data such as the lowBins 530, highBins 532, combinedBins 534, and NodePolygons 510.

The method 700 will continue to split the nodes 816, 818, 828, and 830 until the cost of splitting the nodes reaches a second threshold. The second threshold may be based on the cost of splitting the node exceeding the cost of not splitting the node. The second threshold may be based on a number of polygons. The second threshold may be based on a heuristic method such as the surface area heuristic disclosed above. Referring to FIG. 8E, node 832 represents node 816 continuing to be split. Node 832 may include many nodes. For example, node 816 may be split into nodes until there are approximately 100 polygons associated with a node. So, there may be several layers of nodes until the leaf nodes are reached. Similarly, nodes 834, 836, 838, and 840 represent nodes 818, 828, and 830, respectively, continuing to be split. The method 700 may select to split node 820 when some of the nodes in 832, 834, 836, and 838 have become leaf nodes.

Method 600 will continue to split nodes 822, 824, and 826 as described above. The CPU will continue to split additional nodes assigned to it as described above. Method 600 will finally continue with more nodes for the GPU to split 618 where a queue or ring buffer will not contain any more nodes for the GPU to split. The CPU will finally continue with more nodes for the CPU to split 704 where a queue or ring buffer will not contain any more nodes for the CPU to split. The method 700 with continue with more nodes for the GPU to split 708 where there will be no more nodes for the GPU to split. The method 700 will end 710. Thus a kd-tree 888 will be built by the methods 600 and 700.

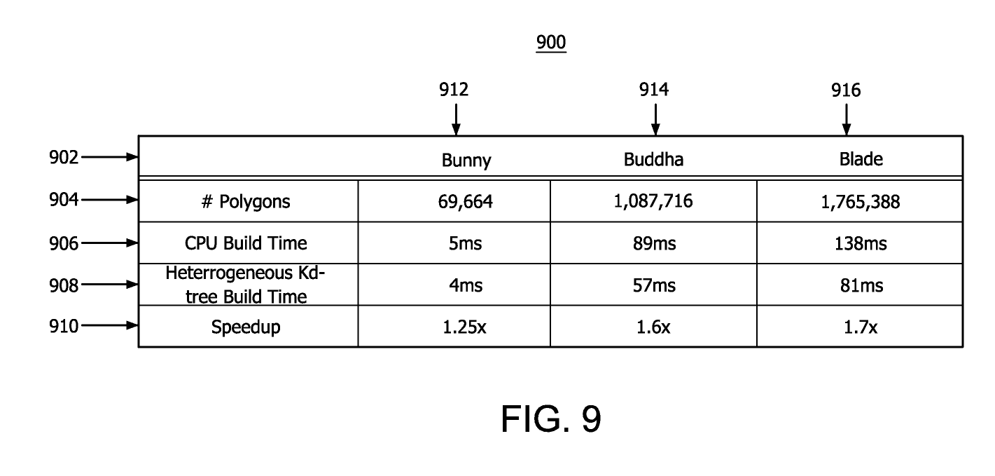

FIG. 9 illustrates estimated speedup times for constructing a kd-tree using a heterogeneous computer system compared with a CPU building a kd-tree. Illustrated in FIG. 9 is a table 900 with objects 912, 914, 916, along one axis and # polygons, CPU build time 906, heterogeneous kd-tree 908, and speedup 910 along a second axis. The table illustrates that an estimated speedup 910 improves with a greater number of polygons 904. For example, for a bunny 912 that is represented with 69,664 polygons the speedup from using the heterogeneous kd-tree 908 is 1.25× whereas the speedup 910 with 1,765,388 polygons for blade 916 is 1.7×. The speedup 910 is estimated based on methods 600 and 700.

In some embodiments, the threshold is set so that the CPU threads do not need to be cooperative CPU threads.

The methods provided may be implemented in a general purpose computer, a processor, or a processor core. Suitable processors include, by way of example, a general purpose processor, a graphics processing unit (GPU), a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the disclosed embodiments.

The methods or flow charts provided herein may be implemented in a computer program, software, or firmware incorporated in a computer-readable storage medium for execution by a general purpose computer or a processor. In some embodiments, the computer-readable storage medium is a non-transitory computer-readable storage medium. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method of building a k-dimensional tree (kd-tree), the method comprising:
a first processor having a first type splitting a node associated with a plurality of polygons into a left node associated with a left portion of the plurality of polygons and a right node associated with the a right portion of the plurality of polygons, wherein the splitting is based on a split plane;
assigning the left node associated with the left portion of the plurality of polygons to the first processor when a number of the left portion of the plurality of polygons is above a threshold and otherwise assigning the left node associated with the left portion of the plurality of polygons to a second processor having a second type, said second type different than said first type; and
assigning the right node associated with the right portion of the plurality of polygons to the first processor when a number of the right portion of the plurality of polygons is above a threshold and otherwise assigning the right node associated with the right portion of the plurality of polygons to the second processor.

2. The method of claim 1 wherein said first processor comprises a graphics processing unit (GPU) and the second processor comprises a central processing unit (CPU).

3. The method of claim 2, further comprising:
the GPU selecting the node to split based on a depth first manner of building the kd-tree.

4. The method of claim 3, wherein the GPU selects the node to split based on the depth first manner of building the kd-tree by at least one of the following: by selecting a last node assigned to the GPU or by selecting a node that is currently in a local memory of the GPU.

5. The method of claim 2, wherein the threshold is based on at least one of: a size of a CPU cache or a number of threads running on the GPU.

6. The method of claim 1, wherein the threshold is determined dynamically.

7. The method of claim 1, wherein assigning the left node associated with the left portion of the plurality of polygons to the first processor further comprises: assigning the left node associated with the left portion of the plurality of polygons to the first processor by placing the left node in a ring buffer.

8. The method of claim 1, further comprising:
the second processor selecting a second node to split based on a depth first manner of building the kd-tree, wherein the first processor selects the node to split based on the depth first manner of building the kd-tree by at least one of the following: by selecting a last node assigned to the second processor or by selecting a node that is currently in a cache memory of the second processor.

9. The method of claim 1, wherein the split plane is determined by each of a plurality of first processor threads determining a low count for each of a plurality of bins and a high count for each of the plurality of bins, and wherein the low count for each of the plurality of bins and the high count for each of the plurality of bins is stored in a local memory.

10. The method of claim 9, further comprising:
combining each of the determined low counts into a combined determined low count in a shared memory, and combining each of the determined high counts into a combined determined high count in the shared memory, wherein the low count for a bin of the plurality of bins is a first number of the plurality of polygons that have a lowest value for a dimension of the split plane in the bin of the plurality of bins, and wherein the high count for a bin of the plurality of bins is a second number of the plurality of polygons that have a highest value for the dimension in the bin of the plurality of bins.

11. The method of claim 9, further comprising:
determining the split plane using the surface area heuristic and the combined determined low count for each of the plurality of bins and the combined determined high count for each of the plurality of bins.

12. The method of claim 1, further comprising:
if the left portion of the plurality of polygons is below a second threshold number than not splitting the left node; and
if the right portion of the plurality of polygons is below the second threshold number than not splitting the right node.

13. A system for building a k-dimensional tree (kd-tree), the system comprising:
a first processor configured to split a node associated with a plurality of polygons into a left node associated with a left portion of the plurality of polygons and a right node associated with the a right portion of the plurality of polygons, wherein the split is based on a split plane,
to assign the left node associated with the left portion of the plurality of polygons to the first processor when a number of the left portion of the plurality of polygons is above a threshold and otherwise assigning the left node associated with the left portion of the plurality of polygons to a second processor, and
to assign the right node associated with the right portion of the plurality of polygons to the first processor when a number of the right portion of the plurality of polygons is above a threshold and otherwise assigning the right node associated with the right portion of the plurality of polygons to the second processor; and
the second processor.

14. The system of claim 13, wherein said first processor comprises a graphics processing unit (GPU) and the second processor comprises a central processing unit (CPU).

15. The system of claim 13, wherein the first processor is further configured to select the node to split based on a depth first manner of building the kd-tree.

16. The system of claim 13, wherein the first processor is further configured to select the node to split based on the depth first manner of building the kd-tree by at least one of the following: by selecting a last node assigned to the first processor or by selecting a node that is currently in a local memory of the first processor.

17. The system of claim 13, wherein the threshold is based on at least one of: a size of a second processor cache or a number of threads running on the first processor.

18. The system of claim 13, wherein the threshold is determined dynamically.

19. The system of claim 13, wherein the first processor is further configured to assign the left node associated with the left portion of the plurality of polygons to the second processor by placing the left node in a ring buffer.

20. The system of claim 13, wherein the second processor is configured to select a second node to split based on a depth first manner of building the kd-tree, wherein the second processor is configured to select the node to split based on the depth first manner of building the kd-tree by at least one of the following: by selecting a last node assigned to the second processor or by selecting a node that is currently in a cache memory of the second processor.

21. The system of claim 13, further comprising:
a local memory of the first processor, wherein the split plane is determined by each of a plurality of first processor threads determining a low count for each of a plurality of bins and a high count for each of the plurality of bins, and wherein the low count for each of the plurality of bins and the high count for each of the plurality of bins is stored in the local memory of the first processor.

22. The system of claim 21, further comprising:
a shared memory of the first processor, wherein the first processor is further configured to combine each of the determined low counts into a combined determined low count in a shared memory, and combine each of the determined high counts into a combined determined high count in the shared memory, wherein the low count for a bin of the plurality of bins is a first number of the plurality of polygons that have a lowest value for a dimension of the split plane in the bin of the plurality of bins, and wherein the high count for a bin of the plurality of bins is a second number of the plurality of polygons that have a highest value for the dimension in the bin of the plurality of bins.

23. The system of claim 21, wherein the first processor is further configured to determine the split plane using the surface area heuristic and the combined determined low count for each of the plurality of bins and the combined determined high count for each of the plurality of bins.

24. The system of claim 13, wherein the first processor is further configured to
determine not to split the left node, when the left portion of the plurality of polygons is below a second threshold number, and
determine not to split the right node, when the right portion of the plurality of polygons is below the second threshold number.
